(19) United States
(12) Patent Application Publication
(10) Pub. No.: US 2023/0211412 A1
(43) Pub. Date: Jul. 6, 2023

(54) CERAMIC-METAL COMPOSITE WEAR PART

(71) Applicant: MAGOTTEAUX INTERNATIONAL S.A., Vaux-sous-Chèvremont (BE)

(72) Inventor: Guy BERTON, Oteppe (BE)

(21) Appl. No.: 18/000,073

(22) PCT Filed: Mar. 25, 2021
(86) PCT No.: PCT/EP2021/057813

§ 371 Date: Nov. 28, 2022

(30) Foreign Application Priority Data
May 29, 2020 (EP) 20177457.7

(51) Int. Cl. B22F 3/23; B02C 13/28; B22D 19/02; B22D 19/06; B22F 3/00; B22F 1/12; B22F 1/105; B22F 1/05

(52) U.S. Cl. CPC B22F 3/23; B02C 13/28; B22D 19/02; B22D 19/06; B22F 1/05; B22F 1/12; B22F 1/105; B22F 3/004; B02C 2210/02; B22F 2005/001

(57) ABSTRACT

The present disclosure relates to a wear part made in a foundry. The wear part has a reinforced portion comprising a ferrous alloy reinforced with metal carbides, nitrides, borides, or intermetallic alloys. The reinforced portion includes inserts of metal carbides, nitrides, metal, or intermetallic compounds manufactured beforehand with a defined geometry and inserted into an infiltrable structure of agglomerated grains including the reagents needed for the formation of metal or intermetallic carbides, nitrides, borides according to an in situ self-propagating thermal reaction initiated during the casting of the ferrous alloy.

### FIELD

The present disclosure relates to a wear part made in a foundry and having a reinforcement structure.

The present disclosure further describes a method for obtaining said wear part with the reinforcement structure thereof.

### INTRODUCTION

Ore extraction and fragmentation installations, and in particular grinding and crushing equipment, are subject to numerous impact and abrasion resistance stresses.

In the field of aggregate, cement and ore processing, wear parts include vertical shaft crusher impellers and anvils, horizontal shaft crusher hammers and beaters, crusher cones, vertical grinder tables and rollers, lining plates and lifters for ball or bar grinders. Regarding mining extraction installations, we will mention, among others, pumps for oil sands or drilling machines, mining pumps and dredging teeth.

Composite wear parts made by casting in a foundry, comprising portions reinforced by ceramics produced in situ during casting by a self-propagating exothermic reaction initiated by the heat of the casting, are well known from the prior art.

Document WO03/047791 describes a wear part with a series of ceramics of the carbide, nitride, boride or intermetallic alloy type formed in situ during a self-propagating exothermic reaction (SHS). The reaction is initiated by the heat of the casting of the metal matrix and propagates rapidly, reaching temperatures above 2000° C.

Documents WO2010/031660; WO2010/0311661; WO2010/031663 and WO 2010/031662 describe wear parts with titanium carbide formed in situ by a self-propagating exothermic reaction. Same relate to a hierarchical reinforcement structure in which the reagents are agglomerated, with an inorganic glue, in the form of millimetric grains assembled in a padding so as to form an infiltrable geometric structure during the self-propagating exothermic reaction initiated by the casting. Such technology creates a structure with alternating areas of low and high concentration of titanium carbide globules, the high concentration areas being located where the reagent grains (in this case, carbon and titanium) precursor of the titanium carbide formation reaction are.

Controlling the in situ ceramic formation reactions which occur at around 2500° C. is difficult, which is why “moderators” such as iron powders are often used so that the reaction is less violent and thus better controlled. However, it has the drawbacks that the ceramic concentrations are diluted and alter the hardness of the whole structure. The concentrations of carbides, nitrides and borides as well as intermetallic alloys are thus limited by this phenomenon.

Maintaining, during casting, the reagent powders in the form of millimetric grains or the inserts compacted according to a predefined geometry can be problematic as well, which can lead to unwanted movements of the reinforced portions.

### SUMMARY

The present disclosure relates to a wear part comprising a portion reinforced according to a predefined geometry with ceramic inserts manufactured beforehand and inserted into an infiltrable structure comprising reagents precursor of the formation of ceramics by a self-propagating exothermic reaction during casting. The present disclosure is aimed at overcoming the drawbacks of the prior art and in particular the difficulty of obtaining reinforcement areas comprising a very high concentration in ceramics (>50% by volume e.g.). Same is further aimed at integrating areas with a high concentration of ceramics in the form of inserts with a predefined geometry within an infiltrable structure of ceramic precursor reagents making it possible at the same time to provide adequate hold of the reinforced portions in the mold during the casting of the wear part.

The present disclosure discloses a wear part including a reinforced portion comprising a ferrous alloy reinforced with metal carbides, nitrides, borides or intermetallic alloys, wherein said reinforced portion comprises inserts with a predefined geometry, said inserts comprising micrometric particles of metal carbides, nitrides, borides or intermetallic compounds prefabricated and embedded in a first metal matrix (10), said inserts being inserted into an infiltrated reinforcement structure comprising a periodic alternation of areas of high and low concentration of micrometric particles of metal carbides, nitrides, borides or intermetallic alloys resulting from agglomerated grains comprising the reagents needed for an exothermic self-propagating in situ synthesis initiated during the casting of the ferrous alloy, said ferrous alloy forming the second metal matrix, the latter being different from said first metal matrix.

The preferred embodiments of the present disclosure include at least one or any suitable combination of the following features:
the metal used for the ceramic particles of the inserts is titanium, the preferred insert mostly comprising micrometric particles of titanium carbide;
the insert comprises a concentration of metal carbides, nitrides, borides or intermetallic elements of up to 90% by volume and at least 30%, preferably at least 40% and particularly preferably at least 50% by volume;
the first metal matrix binding the ceramic particles of the insert mostly comprises nickel, nickel alloy, cobalt, cobalt alloy or a ferrous alloy which is different from the casting alloy forming the second metal matrix;
the insert comprises particles of metal carbides, nitrides, borides or particles of intermetallic alloys with a mean size D₅₀ of less than 80 µm, preferably less than 60 µm and particularly preferably less than 40 µm;
the prefabricated insert and the areas in which the ceramic was formed during the casting include micrometric interstices comprising different metal matrices;
the reinforcement structure consists of an alternation of millimetric areas with a high ceramic concentration resulting from the agglomerates of reagents which have reacted and of millimetric areas with a very low ceramic concentration forming the millimetric interstices infiltrated by the second metal matrix, the casting metal;
the reinforcement structure further comprises millimetric grains of alumina, zirconia or alumina-zirconia alloy.

The present disclosure further discloses a method for manufacturing a wear part, comprising the following steps:
providing a mold comprising the cavity of a wear part with a predefined geometry of an area to be reinforced;
introducing and positioning a compact mixture of powders in said area to be reinforced, in the form of millimetric granules intended for reacting in a self-propagating exothermic reaction in the form of millimetric granules precursor of metal carbides, nitrides, borides or intermetallic compounds, which may be mixed with a moderator powder at least partially surrounding one or several prefabricated inserts which have a defined geometry and are concentrated in metal carbides, nitrides, borides or in intermetallic compounds and comprising the first metal matrix;
casting a ferrous alloy into the mold, said liquid ferrous alloy initiating said self-propagating exothermic reaction leading to the formation of metal carbides, nitrides, borides or intermetallic compounds in said precursor granules;
forming, in the reinforced area of the wear part, an alternating macro-microstructure of periodic millimetric areas of high and low concentration, respectively, of metal carbides, nitrides, borides or intermetallic elements infiltrated by the second metal matrix resulting from the casting, the whole structure at least partially surrounding the insert(s).

According to preferred embodiments of the method according to the present disclosure, the inserts with a predefined geometry manufactured prior to the casting of said wear part have the following features;
the inserts are manufactured by powder metallurgy;
the compact mixture of powders intended for reacting in a self-propagating exothermic reaction in the form of millimetric granules consists of carbon, titanium, a binder and optionally a moderator powder.

The present disclosure further discloses the main applications in the form of an impactor, an anvil, a cone or a grinding roller.

### BRIEF DESCRIPTION OF THE DRAWINGS

FIG. 1 schematically shows a wear part according to the present disclosure with an area reinforced with prefabricated cylindrical inserts made of ceramic-metal composite. These inserts comprise micrometric particles of ceramics bonded in a first metal matrix. These inserts are surrounded by a structure of millimetric areas periodically alternating in high and low concentrations of ceramics resulting from the SHS reaction of millimetric grains of precursor reagents infiltrated by the casting metal that forms the second metal matrix which initiated an in situ exothermic reaction forming micrometric ceramic particles, next to the prefabricated ceramic inserts. The second metal matrix is different from the first metal matrix.

FIG. 2 schematically represents the detail of a reinforcement insert according to the present disclosure, consisting of prefabricated cylindrical inserts in ceramic-metal composite set in a structure of millimetric grains of precursor reagents infiltrable by the casting metal which will initiate an in situ exothermic ceramic formation reaction next to the pre-fabricated ceramic inserts.

FIG. 3 schematically represents a moving crusher cone with the predefined area to be reinforced by prefabricated cylindrical inserts in ceramic-metal composite surrounded by a structure of millimetric grains of infiltrable precursor reagents.

FIG. 4 schematically represents a crusher hammer with the predefined area to be reinforced by prefabricated cylindrical inserts in ceramic-metal composite surrounded by a structure of millimetric grains of infiltrable precursor reagents.

FIG. 5 schematically represents a crusher beater with the predefined area to be reinforced by prefabricated cylindrical inserts in ceramic-metal composite surrounded by a structure of millimetric grains of infiltrable precursor reagents.

FIG. 6 schematically represents an excavator tooth with the predefined area to be reinforced by prefabricated cylindrical inserts in ceramic-metal composite surrounded by a structure of millimetric grains of infiltrable precursor reagents.

FIG. 7 is a photograph of a real reinforcement structure on which the ceramic-metal composite inserts can be seen placed in a three-dimensional structure of reactive ceramic precursor grains which will be transformed into ceramics during casting.

FIG. 8 represents an impactor according to the prior art, after wear. The contour line represents the contour of the part before wear.

FIG. 9 represents an impactor according to the present disclosure, after wear. The contour line represents, here as well, the part before wear. The inserts surrounded by the infiltrated three-dimensional structure are apparent. Same have resisted wear better.

FIG. 10 schematically shows the method for measuring the Feret diameter (with the minimum and maximum Feret diameters). The Feret diameters are used in the method for obtaining the mean size of the ceramic-metal particles (as explained hereinafter).

FIG. 11 is a graph of a wear rate the ceramic-metal composites vs. properties of the ceramic particles, the proportion and distribution thereof, and the nature of the binder used.

FIG. 12 is a graph depicting how, as the modulus of elasticity of particles increases, the more the impact resistance thereof increases.

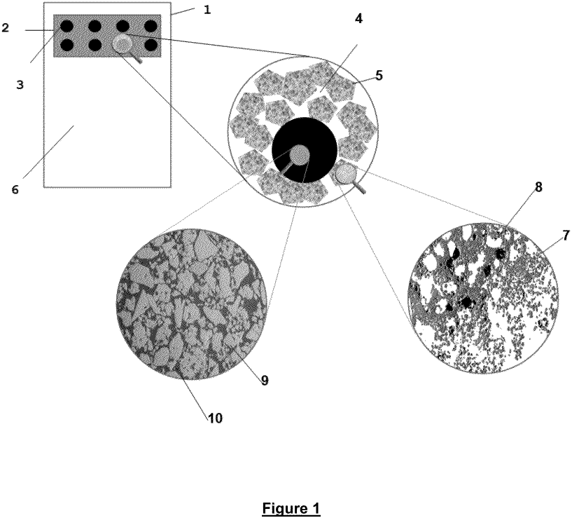

### LIST OF REFERENCE SYMBOLS

1: composite wear part reinforced by a ceramic composition at the locations which are most exposed to wear.

2: reinforcement structure with a predefined geometry infiltrated by the casting metal, the structure comprising, before infiltration, reagents needed for the formation, by a self-propagating exothermic reaction, of a ceramic made of metal carbides, nitrides, borides or intermetallic alloys.

3: prefabricated insert in ceramic-metal composite comprising a metal matrix different from the casting metal, the insert being integrated into the infiltrable structure, the whole structure being placed into the mold designed for receiving the casting metal.

4: reinforcement structure detail showing an area with a low concentration of formed ceramic particles.

5: reinforcement structure detail showing an area with a high concentration of formed ceramic particles.

6: casting metal.

7: globular particles of metal carbides, nitrides, borides or intermetallic elements formed in situ during casting, by a self-propagating exothermic reaction. Reaction initiated by the heat of the casting.

8: micrometric interstices between the ceramic particles infiltrated by the casting metal of the wear part (steel or cast iron) or partially consisting of a moderator metal.

9: prefabricated ceramic particles which may represent up to 90% of the total volume of the insert, but which represent at least 10% by volume, preferably at least 20 or 30%, particularly preferably 40 or 50% of the volume of the insert. The inserts can be manufactured by any technology but are preferably manufactured by powder metallurgy.

10: first metal matrix which serves as a binder for the ceramic particles of the prefabricated insert. The first metal matrix is different from the second metal matrix resulting from the casting metal which infiltrates the infiltrable structure.

11: diagram of a movable cone of a crusher comprising a reinforced structure according to the present disclosure.

12: diagram of a breaker hammer comprising a reinforced structure according to the present disclosure.

13: diagram of a beater of a crusher comprising a reinforced structure according to the present disclosure.

14: diagram of an excavator tooth comprising a reinforced structure according to the present disclosure.

### DETAILED DESCRIPTION

The present disclosure discloses a wear part with increased wear resistance, made in a conventional foundry. It relates more particularly to a wear part comprising a reinforced portion according to a predefined geometry with ceramic inserts on the scale of a few centimeters, manufactured beforehand and inserted into an infiltrable three-dimensional structure consisting of agglomerated millimetric grains and forming a periodic alternation of grains and millimetric interstices. The grains comprise reagents needed for the formation of ceramics by a self-propagating exothermic reaction during casting.

The infiltrable structure thus consists of an aggregate of millimetric grains with a mean size between 0.5 and 10 mm, preferably between 0.7 to 6 mm and particularly preferably between 1 and 4 mm. The interstices between the grains depend on the degree of compaction and on the size of the grains but are of about a millimeter or a fraction of a millimeter. The millimetric grains contain a homogeneous mixture of reactive powders with, if need be, a moderator powder, and can be agglomerated/compacted together using a binder or held in a metal container so as to geometrically delimit the reinforced area of the wear part.

The ceramic inserts manufactured beforehand and designed for being held by the three-dimensional structure of agglomerated grains may have any shape, even though a cylindrical or approximately cylindrical shape is preferred. The size of these ceramic inserts manufactured beforehand corresponds, in the case of a cylindrical shape, to a diameter of 3 to 50 mm, preferably 6 to 30 mm, more particularly 8 to 20 mm and to a height of 5 to 300 mm, preferably 10 to 200 mm, more particularly 10 to 150 mm.

The present disclosure thus describes a wear part reinforced, on the side or sides thereof most subject to wear, by, on the one hand, a preformed ceramic (ceramic-metal composite) usually obtained by powder metallurgy, comprising a first metal matrix binding the micrometric particles of ceramics, and, on the other hand, a ceramic formed in situ during the casting of steel or liquid cast iron (the second metal matrix), the first metal matrix being completely independent of the second metal matrix, which makes same manageable in a custom-made manner.

This technique can be used for a convenient and firm positioning of prefabricated inserts with a defined geometry, concentrated in metal carbides, nitrides, borides or intermetallic alloys and comprising a metal matrix independent of the matrix generated by the casting. The metal matrix existing prior to the casting of the wear part is present from the start in the ceramic-metal composite inserts that are integrated into an infiltrable structure consisting of agglomerated millimetric grains (padding) comprising the reagents needed to form the ceramic materials which are necessary for a self-propagating exothermic reaction and which are formed during the casting of the wear part by the initiation of an SHS (self-propagating high-temperature synthesis) reaction:
https://en.wikipedia.org/wiki/Self-propagating_high-temperature_synthesis).

Contrary to what is practiced in the prior art, preformed ceramic-metal composite inserts are partially used herein, as e.g. a cylindrical or frustoconical insert. Such insert can consist e.g. of titanium carbides, titanium nitrides or chromium carbides with a minimum concentration of 40% by volume in a first metal matrix containing for example iron, manganese, nickel or cobalt (e.g. compositions of the DIN 1.3401 or DIN 2.4771type) which is “wrapped” in an infiltrable structure made for example of an agglomerate of millimetric grains of a mixture of carbon and titanium, which may be diluted by a moderator such as iron or steel powder (e.g. 45CrMoV67 steel), which is transformed, during the casting of the wear part, into TiC formed in situ by a self-propagating exothermic reaction. The TiC formed in situ and infiltrated at least partially by the casting metal (second metal matrix) produces a “hybrid” structure with areas with a high concentration of TiC at the location of the geometrical inserts manufactured beforehand with their own metal matrix (first metal matrix containing Ni, Mn, Co, steel, Ni alloy), at least partially surrounded by a structure in which the ceramics have been formed in situ and in which the interstices have been infiltrated by the casting metal of the wear part. It is thus an area reinforced by prefabricated ceramic-metal inserts surrounded by a periodic alternation of millimetric areas of high and low concentration of ceramics resulting from the structure of agglomerated reagent grains (Ti + C for example) which were transformed, during casting, into titanium carbide by SHS reaction.

The expression “TiC” should not be interpreted in the strict chemical sense of the term but as titanium carbide in the crystallographic sense because titanium carbide has a wide composition range, from a stoichiometric C/Ti ratio of 0.47 to 1. The same applies to other ceramics such as nitrides and borides, the stoichiometric variations of which can be relatively large.

The present disclosure can thus be used not only for achieving very high concentrations of ceramics that are generally greater than 40% by volume and may reach up to 90% by volume in the prefabricated inserts, but also for choosing the first metal matrix specific for these prefabricated inserts and thus for being independent of the casting metal (second metal matrix) of the wear part which is often cast iron or chromium steel.

The reagents used to produce the infiltrable structure of agglomerated millimetric grains can be chosen from the group of ferroalloys, preferably FerroTi, FerroCr, FerroNb, FerroW, FerroMo, FerroB, FerroSi, FerroZr or FerroV. They can also belong to the group of oxides, preferably TiO₂, FeO, Fe₂O₃, SiO₂, ZrO₂, CrO₃, Cr₂O₃, B₂O₃, MoO₃, V₂O₅, CuO, MgO and NiO, or to the group of metals or the alloys thereof, preferably iron, nickel, titanium or aluminum on the one hand and carbon, boron or nitrided compounds as a balance on the other hand, for forming the corresponding carbides, borides or nitrides.

As a non-limitative example, the reactions which can be used for the formation of the “wrapping” structure allowing preformed ceramic-metal inserts to be positioned in the mold for the manufacture of the wear part are usually such as:

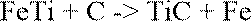

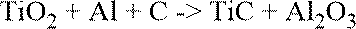

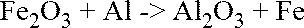

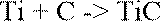

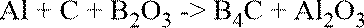

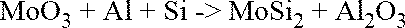

These reactions can also be combined together.

As mentioned above, the reaction rate can be controlled by a moderator in the form of different additions of metals, alloys or particles not participating in the reaction (e.g. alumina-zirconia grains). These additions, when they are reagents, can be further advantageously used for modifying, as required, the toughness or other properties of the structure which was created in situ. This is represented by the following illustrative reactions:

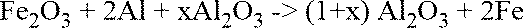

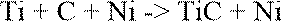

As a non-limitative example, the geometric ceramic inserts manufactured beforehand can be made of titanium carbides, titanium nitrides, titanium carbonitrides, chromium carbides, chromium nitrides, chromium carbonitrides, niobium carbides or tungsten carbides, taken individually or in a mixture thereof.

The present disclosure provides better performance for the reinforced wear parts made in a foundry compared to the wear parts of the prior art owing to the localized increase in wear resistance of the area reinforced by the presence of an increased number of wear-resistant particles and/or particles of a different nature, by means of a more suitable metal matrix. It further provides better performance of the manufactured wear parts by adding areas with a defined geometry concentrated in metal carbides, nitrides, borides or intermetallic alloys and a first metal matrix which is there prior to the casting of said wear part and by avoiding the preferential wear of the ferrous alloy of the wear part around such areas thanks to the structure alternating, on a millimetric scale, areas thick with fine micrometric globular particles of metal carbides, for example formed in situ by an SHS method, with areas which are practically free of same within the metal matrix of the part, in the vicinity of said areas, i.e. in the “wrapping” structure of the prefabricated ceramic inserts, while improving the cohesion of the inserts with the ferrous alloy of the reinforced wear part.

### Measurement Method

### Mean Size of the Particles of Metal Carbides, Nitrides, Borides or Intermetallic Alloys

The calculation of the mean size d₅₀ of the particles of metal carbides, nitrides, borides or particles of intermetallic alloys is performed through the following steps.

First, a photomicrographic panorama of the polished cross-section of a sample is made, so that there are at least 250 complete particles across the field of view. The panorama is performed by stitching (a process of combining a series of digital images of different parts of a subject into a panoramic view of the whole subject so as to maintain good definition) using a computer program and an optical microscope (e.g., a general image field panorama obtained using an Alicona Infinite Focus).

An appropriate thresholding is then carried out for segmenting the image into features of interest (the particles) and background, in different levels of grey.

If the thresholding is inconsistent due to poor image quality, a manual step of drawing the particles, the scale bar if present, and the frame of the image on tracing paper is added, as well as a step of scanning the tracing paper.

The Feret diameter (which corresponds to the distance between two parallel tangents, placed perpendicular to the measurement direction in such a way that the entire projection of the particle lies between the two tangents) is measured by an image analysis software (imageJ e.g.) for each particle, in all directions. An example is shown in FIG. 10.

The minimum and maximum Feret diameters are then determined for each granule in the image. The minimum Feret diameter is the smallest diameter of the set of Feret diameters measured for a particle. The maximum Feret diameter is the largest diameter of the set of Feret diameters measured for a particle. Particles touching the edges of the image are ignored in the calculation.

The mean value of the minimum and maximum Feret diameters of each particle is taken as an equivalent diameter x. The volume distribution of the particle sizes q₃ (x) is then calculated based on spheres of diameter x.

The mean granule size d₅₀ is the volume-weighted mean size _{X} ̅_{1,3} according to the ISO 9276-2: 2014 standard.

### EXAMPLES

### Comparative Example

In the present example, the resistance of a reinforced part is measured. The wear part is manufactured similarly to the method disclosed in the prior art (WO2010/031663). The prior art describes a composite impactor for impact crushers comprising a ferroalloy which is reinforced, on the side thereof most exposed to wear, with a three-dimensional structure of millimetric titanium carbide precursor grains. The wear part is produced by in situ self-propagating exothermic synthesis. The impactor weighs 52 kg and is reinforced in a volume of about 0.88 dm³.

To evaluate the degree of wear, the overall weight loss of the impactor is measured. In practice, this is the only way to determine wear, which depends on a series of factors and in particular on the positioning geometry of the reinforcement in the impactor. Although the impactor is mostly worn on the side of the reinforcement, the impactor is also partially worn outside the reinforcement depending on the positioning. The comparison of the corresponding wears between the impactor according to the prior art and the impactor according to the present disclosure is illustrated in FIGS. 8 and 9.

In the three-dimensional structure of the reinforcement according to the prior art, there is a periodic alternation between millimetric grains and interstices. The grains comprise a mixture of titanium powder with a mean particle size of 60 µm and a minimum purity of 98%, graphite powder with a particle size of less than 30 µm and a purity of about 99%, and steel powder with a particle size of less than 60 µm as a reaction moderator. These millimetric grains of about 2.5 mm in diameter are compacted with a porosity of less than 20%. The chemical composition of such grains is given in the following table for 100 kg of grains.

| | | |
|---|---|---|
| Titanium | Carbon | Moderator 45 CrMoV 6 7 steel |
| 63.82 kg | 14.70 kg | 21.48 kg |

The comparative example thus has portions reinforced with titanium carbides produced exclusively by in situ self-propagating thermal synthesis of titanium and carbon so as to form titanium carbide during casting. The reaction is initiated by the casting of the ferrous alloy consisting of a 12CrMoV martensitic stainless steel which is further used for the examples according to the present disclosure.

The wear part thus contains exclusively a three-dimensional structure of alternating areas of high and low concentration of titanium carbides which are produced in situ on the most stressed side of the wear part during the casting, without initially containing ceramic-metal composite inserts, of the cylinder type for example, which are formed beforehand in a metal matrix different from the ferrous alloy used for the casting. At the end of these steps, a shape with a total reinforced volume of 0.88 dm³ is manufactured. The weight loss observed during a wear test is 3.63 kg per 100 hours of operation (kg/100 h) on the composite impactor for impact crushers. For the examples according to the present disclosure, the same conditions of use and material to be ground are repeated.

### Examples According to the Present Disclosure

### Example 1

The reinforced part according to the present disclosure comprises a reinforced area with a predefined geometry with ceramic inserts manufactured beforehand on a scale of a few centimeters and inserted beforehand into an infiltrable structure comprising the reagents needed for the formation of ceramics by a self-propagating exothermic reaction during the casting. The infiltrable structure consists of an aggregate of millimetric grains with a mean size of about 2.5 mm containing the reagents needed for the reaction. The grains are agglomerated according to a predefined shape into a three-dimensional structure using an organic binder such as a phenolic resin in a resin mold. In this three-dimensional structure, there is a periodic alternation between millimetric grains and interstices. This configuration is shown in FIG. 7.

The grains comprise a mixture of titanium powder with a mean particle size of 60 µm and a purity of 98%, graphite powder with a mean particle size of 30 µm and a purity of 99%, and steel powder with a mean particle size of 60 µm and comprising 45CrMoV67 steel powder as a reaction moderator. The millimetric grains are compacted with a porosity of less than 20%. The chemical composition of these grains is given in the following table for 100 kg of grains

| | | |
|---|---|---|
| Titanium | Carbon | Moderator 45 CrMoV 6 7 steel |
| 63.82 kg | 14.70 kg | 21.48 kg |

The ceramic inserts manufactured beforehand have a cylindrical geometric shape. The diameter of these ceramic inserts manufactured beforehand is 12 mm, the height is 20 mm. Same consist of 70-80% of titanium carbides, 1-3% of chromium carbides and a binder containing DIN 1.3401 austenitic manganese steel. This binder forms the first metal matrix.

67 ceramic inserts, vertically manufactured beforehand, are positioned in a predefined manner in the resin mold, which defines the reinforcement area by means of notches made in the resin mold, prior to the addition of the reactive millimetric grains which are intended for the self-propagating exothermic reaction and will be agglomerated by means of the organic binder.

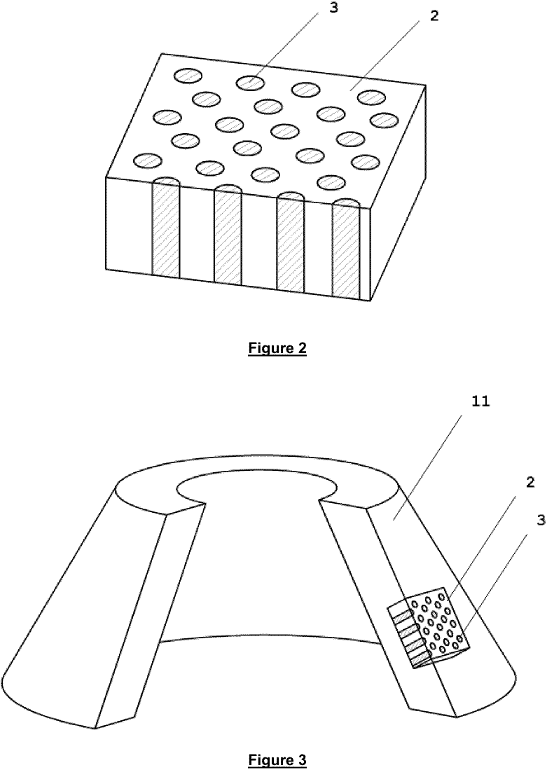

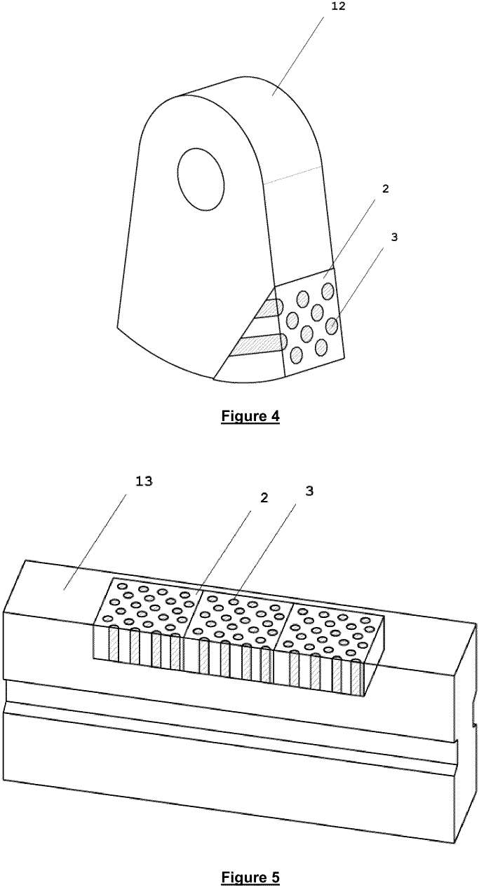

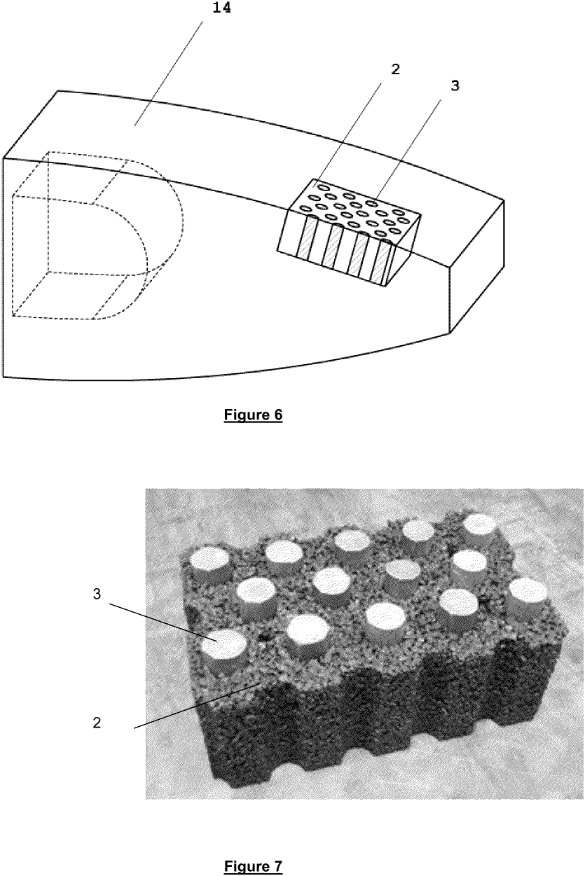

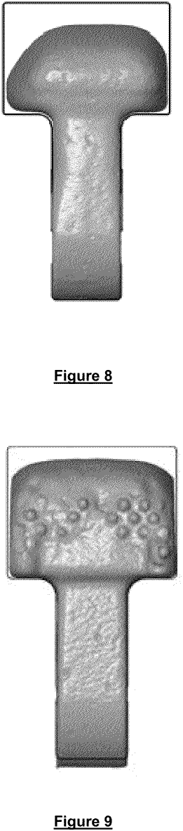

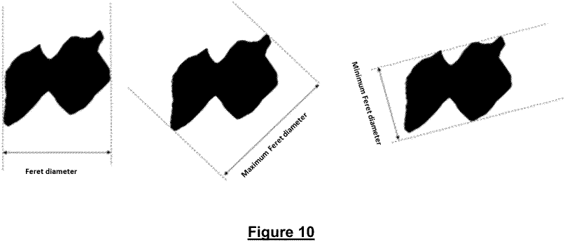

At the end of these steps, a three-dimensional structure with a total volume of 0.88 dm³, similar to FIG. 2, is manufactured by casting a 12CrMoV alloy with the following composition: 0.15-0.20% C; 9.00-11.00% Cr; 0.60-1.10% Mn and 0.35-0.65% Si. The latter forms the second metal matrix.

| Ex 1 (67 preformed inserts) | Alloy of titanium and chromium carbides (70-80%) surrounded by precursor reagents in titanium + carbon grains with 45 CrMoV 6 7 steel powder as moderator |
|---|---|
| Weight loss per 100 hours (kg/100 h) | 2.02 |
| Coefficient of superiority compared to the comparative example | 1.80 |

### Example 2

Example 1 is repeated, but this time, 77 ceramic inserts manufactured beforehand are positioned in a predefined manner in the resin mold which defines the reinforcement area by means of notches made in the resin mold and prior to the addition of the reactive millimetric grains intended for the self-propagating exothermic reaction, which will be agglomerated by means of the same organic binder. At the end of these steps, a three-dimensional structure with a total volume of 0.88 dm³, similar to FIG. 2, is manufactured.

The ceramic inserts manufactured beforehand consist of 70-80% of titanium carbides, 1-3% of chromium carbides and a binder as first metal matrix containing a DIN 1.3401 austenitic manganese steel.

| Ex. 2 (77 preformed inserts) | Alloy of titanium and chromium carbides (70-80%) surrounded by precursor reagents in titanium + carbon grains with 45 CrMoV 6 7 steel moderator |
|---|---|
| Weight loss per 100 hours (kg/100 h) | 2.06 |
| Coefficient of superiority compared to the comparative example | 1.76 |

### Example 3

Example 1 is repeated with 67 inserts, but this time, the ceramic inserts manufactured beforehand comprise 75-85% of titanium carbonitrides and a binder containing a DIN 2.4771 nickel and chromium alloy as first metal matrix.

| Ex.3 (67 preformed inserts) | Alloy of titanium carbides and nitrides (75-85%) surrounded by precursor reagents in titanium + carbon grains with 45 CrMoV 6 7 moderator steel |
|---|---|
| Weight loss per 100 hours (kg/100 h) | 1.95 |
| Coefficient of superiority compared to the comparative example | 1.86 |

### Example 4

This is an example with a system of grains precursor of a self-propagating exothermic synthesis (SHS): Ti+V+C.

These particles consist of a mixture of titanium powder with a mean particle size of 60 µm and a purity of 98%, vanadium powder with a particle size of less than 200 mesh and graphite powder with a particle size of less than 30 µm and a purity of 99%. These particles are compacted with a porosity of less than 22%. The chemical composition of the particles is given in the following table.

| | | |
|---|---|---|
| Titanium | Carbon | Vanadium |
| 67.01 kg | 31.23 kg | 71.32 kg |

Example 1 is repeated, again with 67 inserts of the same size, but the ceramic inserts manufactured beforehand now comprise 70-80% of chromium carbides and a binder containing a DIN 2.4771 nickel and chromium alloy as first metal matrix.

| Ex. 4 (67 preformed inserts) | Inserts in chromium carbides (70-80%) surrounded by precursor reagents in titanium + carbon + vanadium grains |
|---|---|
| Weight loss per 100 hours (kg/100 h) | 2.23 |
| Coefficient of superiority compared to the comparative example | 1.63 |

### Example 5

This is an example with a system of grains precursor of a self-propagating exothermic synthesis (SHS): Ti+V+B₄C.

These particles consist of a mixture of titanium powder with a particle size of approximately 60 µm and a purity of 98%, boron carbide powder with a particle size of less than 150 mesh and graphite powder with a mean particle size of 30 µm and a purity of 99%.

These particles are compacted with a porosity of less than 22%. The chemical composition of the particles is shown in the following table.

| | | |
|---|---|---|
| Titanium | Carbon | Boron carbide |
| 20.10 kg | 16.01 kg | 7.736 kg |

The 67 ceramic inserts manufactured beforehand comprise 80-90% of chromium carbides and a binder containing a 2.4771 nickel and chromium alloy, as first metal matrix.

| Ex. 5 (67 preformed inserts) | Inserts in chromium carbides (80-90%) surrounded by precursor reagents in titanium + carbon grains mixed with boron carbide |
|---|---|
| Weight loss per 100 hours (kg/100 h) | 2.72 |
| Coefficient of superiority compared to the comparative example | 1.33 |

### Example 6

This is an example with a system of grains precursor of a self-propagating exothermic synthesis (SHS): Ti+C surrounded by non-reactive alumina-zirconia grains so as to moderate the self-propagating exothermic reaction.

The precursor grains comprise a mixture of titanium powder with a mean particle size of about 60 µm and a purity of 98%, graphite powder with a mean particle size of 30 µm and a purity of 99%. These millimetric precursor grains of about 2.5 mm are compacted with a porosity of less than 20%. The chemical composition of these grains is given in the following table for 100 kg of grains.

| Titanium | Carbon | 60/39/0.15 alumina-zirconia/titanium oxide as moderator |
|---|---|---|
| 63.95 kg | 16.05 kg | 20.00 kg |

The non-reactive grains contain alumina-zirconia with a proportion of 60% of alumina, 39% of zirconia and 0.15% of titanium oxide.

The mean size of these non-reactive millimetric grains is 2.1 mm.

The ceramic inserts manufactured beforehand consist on average of 70-80% of titanium carbides, 1-3% of chromium carbides and a binder containing DIN 1.3401 austenitic manganese steel forming the first metal matrix.

The proportion by weight of non-reactive grains compared to the exothermic reaction precursor grains may vary in volume between 5 and 40%, preferably between 10 and 30%, more preferably between 15 and 20%. In the present example, the proportion is 20% by weight.

| Ex 6 (67 preformed inserts) | Alloy of titanium and chromium carbides (70-80%) surrounded by precursor reagents in titanium + carbon grains and non-reactive grains comprising alumina-zirconia |
|---|---|
| Weight loss per 100 hours (kg/100 h) | 2.82 |
| Coefficient of superiority compared to the comparative example | 1.29 |

### Summary Table and Interpretation of the Results

The table below shows the weight losses of a 52 kg impactor in new condition, the reinforced volume of which represents about 0.88 dm³. The weight loss was measured after 696 hours of operation and reduced to 100 hours of operation.

| Ex | Reinforcement surrounding the preformed insert | Preformed insert | Number of preformed inserts | Composite impactor wear (kg/100 h) | Gain % |
|---|---|---|---|---|---|
| C. | Titanium + carbon + 45 CrMoV 67 moderator steel powder | - | - | 3.63 | - |
| 1 | Titanium + carbon + 45 CrMoV 67 moderator steel powder | alloy of titanium and chromium carbides (70- 80%) | 67 | 2.02 | 80 |
| 2 | Titanium + carbon + 45 CrMoV 67 moderator steel powder | alloy of titanium and chromium carbides (70- 80%) | 77 | 2.06 | 76 |
| 3 | Titanium + carbon + 45 CrMoV 67 moderator steel powder | alloy of titanium carbides and nitrides (75-85%) | 67 | 1.95 | 86 |
| 4 | Titanium + carbon + vanadium | chromium carbides (70-80%) | 67 | 2.23 | 63 |
| 5 | Titanium + carbon + boron carbide | chromium carbides (80-90%) | 67 | 2.72 | 33 |
| 6 | Titanium + carbon + non-reactive grains comprising alumina - zirconia | alloy of titanium and chromium carbides (70- 80%) | 67 | 2.82 | 29 |

### Interpretation of Results

The wear performance of the different examples is a combination of the wear rate of the reinforcement surrounding the preformed insert, the preformed insert per se and the unreinforced area of the impactor. Thus, the wear rates of these different areas have been evaluated so as to explain the difference in performance in the different examples.

The following table shows the wear rates of the different parts in kg per 100 hours of operation.

| Ex | Preformed inserts (kg/100 h) | Reinforcement surrounding the preformed inserts (kg/100 h) | Unreinforced area of the impactor (kg/100 h) |
|---|---|---|---|
| Comp. | | | 2.77 |
| 1 | 0.19 | 0.33 | 1.50 |
| 2 | 0.19 | 0.31 | 1.56 |
| 3 | 0.16 | 0.34 | 1.45 |
| 4 | 0.33 | 0.39 | 1.51 |
| 5 | 0.36 | 0.42 | 1.94 |
| 6 | 0.23 | 0.61 | 1.98 |

The table shows that the wear rate of the preformed inserts depends on the features thereof and the performance classification of the preformed inserts in the examples previously described is as follows (from the most efficient to the least efficient):
a) 75-85% of titanium carbonitrides and a binder containing nickel alloy
b) 70-80% of titanium carbides, 1-3% of chromium carbides and an austenitic steel binder
c) 70-80% of chromium carbides and a nickel-based binder
d) 80-90% of chromium carbides and a nickel-based binder

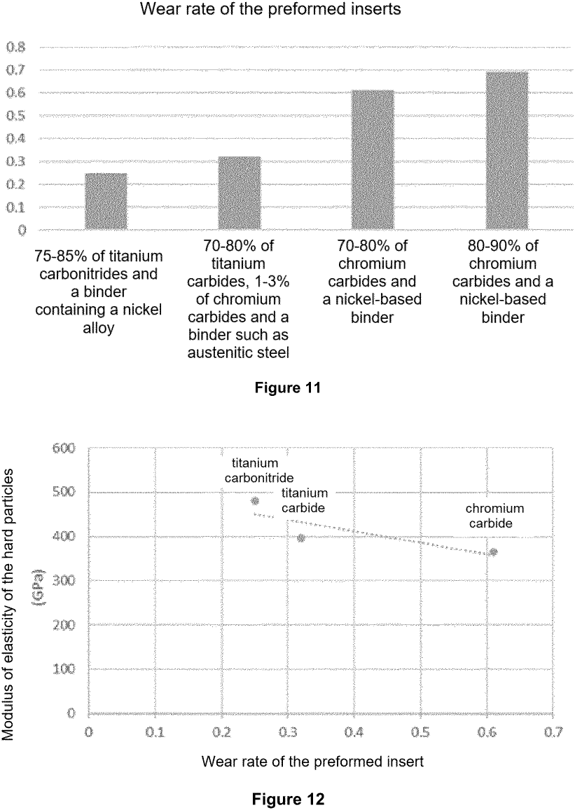

Indeed, the wear resistance of the ceramic-metal composites depends on the properties of the ceramic particles, the proportion and distribution thereof, and on the nature of the binder used. See FIG. 11.

Without claiming a scientifically rigorous explanation, it is generally accepted that there is a link between the performance of the different ceramic-metal composites used as preformed inserts and the modulus of elasticity of the hard particles of the components. Indeed, it is known that the more the modulus of elasticity of the particles increases, the more the impact resistance thereof increases because the deformation of the particles at equivalent stresses decreases. This relationship is illustrated in FIG. 12.

It also entails that chromium carbides are more brittle than carbides or carbonitrides containing titanium, which explains the lower performance of example 5 compared with example 4, despite a higher percentage of chromium carbides in the preformed inserts.

1. A wear part including:
a reinforced portioncomprising a ferrous alloy reinforced with metal carbides, nitrides, borides, or intermetallic alloys,
wherein said reinforced portioncomprises inserts having a predefined geometry,
said insertscomprising particles of metal carbides, nitrides, borides, or intermetallic compounds prefabricated and embedded in a first metal matrix,
said insertsbeing inserted into a reinforcement structurealternating areas having a high concentrationof globular particlesof metal carbides, nitrides, borides, or intermetallic alloys with areas being free of the globular particles,
said ferrous alloy forming a second metal matrix different from said first metal matrix.

2. The wear partaccording to claim 1, wherein the metalused for the ceramic particles of the insertsis titanium, and the inserts comprise micrometric particles of titanium carbides.

3. The wear part according to claim 1, wherein the insertcomprises a concentration of metal carbides, nitrides, borides, or intermetallic elements of up to 90% by volume and at least 30%, by volume.

4. The wear part according to claim 1, wherein a majority of the first metal matrix binding the ceramic particles of the insertcomprises nickel, nickel alloy, cobalt, cobalt alloy, or a ferrous alloy which is different from a casting alloy forming the second metal matrix.

5. The wear part according to claim 1, wherein the insertcomprises particlesof metal carbides, nitrides, borides_{,} or particles of intermetallic alloys having a mean size D₅₀ of less than 80 µm.

6. The wear part according to any of the preceding claim 1, wherein the insertand the areas in which the ceramic was formed during castingcomprise micrometric interstices comprising different metal matrices.

7. The wear part according to preceding claim 1, wherein the reinforcement structureconsists of an alternation of millimetric areas having a higher ceramic concentration resulting from the agglomerates of reagents having reacted and of millimetric areas having a lower ceramic concentrationforming the millimetric interstices infiltrated by the second metal matrix.

8. The wear part according to preceding claim 1, wherein the reinforcement structurefurther comprises millimetric grains of alumina, zirconia, or alumina-zirconia alloy.

9. The wear part according to claim 1, manufactured in the form of an impactor, an anvil, a cone, or a grinding roller.

10. A method for manufacturing the wear part of claim 1, the method comprising the following steps:
providing a mold comprising the cavity of the wear part having a predefined geometry of an area to be reinforced;
introducing and positioning a compact mixture of powders in said area to be reinforced, in the form of millimetric granules configured to react in a self-propagating exothermic reaction, the millimetric granules being precursors of metal carbides, nitrides, borides, or intermetallic compounds, optionally mixed with a moderator powder at least partially surrounding one or several prefabricated inserts having a defined geometry and concentrated in metal carbides, nitrides, borides, or in intermetallic compounds and comprising the first metal matrix;
casting a liquid ferrous alloy into the mold, said liquid ferrous alloy initiating said self-propagating exothermic reaction leading to the formation of metal carbides, nitrides, borides, or intermetallic compounds in said precursor granules;
forming, in the reinforced area of the wear part, an alternating macro-microstructure of periodic millimetric areas of high and low concentration, respectively, of metal carbides, nitrides, borides, or intermetallic elements infiltrated by the second metal matrix resulting from the casting, the whole structure at least partially surrounding the insert(s).

11. The method according to claim 10, wherein the prefabricated inserts are manufactured by powder metallurgy.

12. The method according to claim 10, wherein the compact mixture of powders consists of carbon, titanium, a binder, and optionally the moderating powder.
